(19) United States
(12) Patent Application Publication
(10) Pub. No.: US 2007/0072005 A1
(43) Pub. Date: Mar. 29, 2007

(54) Magnetic thin film for high frequency, method of manufacturing the same, and magnetic device

(75) Inventors: Kyung-Ku Choi, Tokyo (JP); Yohtaro Yamakazi, (US); Taku Murase, (US)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 10/571,000

(22) PCT Filed: Sep. 10, 2004
(86) PCT No.: PCT/JP04/13237

§ 371 Date: Nov. 2, 2006

(30) Foreign Application Priority Data
Sep. 11, 2003 (JP) 2003-319195

(51) Int. Cl. B32B 15/00; G11B 5/33; B05D 5/12

(52) U.S. Cl. 428/692.1; 428/812; 427/127

(57) ABSTRACT

By using a DM (discontinuous multilayer) structure formed of ferromagnetic metal in amorphous state and amorphous metal different from the ferromagnetic metal, a magnetic thin film for high frequencies is realized that has a high magnetic permeability in a high-frequency region of a GHz band and that has a high saturated magnetization. This magnetic thin film for high frequencies is preferably provided so that: (i) the ferromagnetic metal is predominantly composed of Fe or FeCo and contains one or more elements selected from the group of C, B, and N and the amorphous metal is a Co-base amorphous alloy; and (ii) the amorphous metal is CoZrNb.

### TECHNICAL FIELD

The present invention relates to a magnetic thin film for high frequencies that has a high saturated magnetization and that shows high magnetic permeability and quality factor Q in a GHz band, to the method of manufacturing the same, and to a magnetic device having the magnetic thin film for high frequencies. More particularly, the present invention relates to a magnetic thin film for high frequencies preferably used for a high-frequency flat type magnetic device such as thin film inductor, thin film transformer or the like, or a monolithic microwave integrated circuit (hereinafter simply referred to as MMIC).

### BACKGROUND ART

In accordance with the recent magnetic devices having a smaller size and a higher performance, a magnetic thin-film material having a high saturated magnetization and showing a high magnetic permeability in a GHz band is demanded.

For example, an MMIC which has been increasingly used mainly for wireless transmitter/receivers and handheld terminals is a high-frequency integrated circuit that is prepared by manufacturing, on a semiconductor substrate (e.g., Si, GaAs, InP), an active device (e.g., transistor) and a passive device (e.g., line, resistance, capacitor, inductor) in a collective and integrated manner. In this MMIC, a passive device (e.g., inductor, capacitor) occupies larger area than that occupied by an active device. The large area occupied by the passive device in the MMIC leads to the consumption of a large amount of a high-cost semiconductor substrate, thus causing an increased cost of the MMIC. In order to reduce the manufacturing cost of the MMIC, a chip area needs to be reduced. To do so, an area occupied by the passive device needs to be reduced.

The above-described MMIC uses a large amount of a flat type spiral coil as an inductor. In the flat type spiral coil, in order to obtain the same inductance as that of a conventional design even when the coil can occupy a small area, the upper and lower faces or one face include(s) a soft magnetic thin film to increase the inductance (e.g., see J. Appl. Phys., 85, 7919 (1999)). However, in order to apply a magnetic material for an inductor of the MMIC, it is firstly required to develop a soft magnetic thin-film material that has a high magnetic permeability in a GHz band and that has small high-frequency loss. It is also required to provide, in order to reduce eddy current loss at a high frequency, a material having a high resistivity.

By the way, one well known conventional magnetic material having a high saturated magnetization is alloy including Fe or FeCo as a major component. However, when a magnetic thin film composed of Fe-base alloy or FeCo-base alloy is manufactured by a film formation technique (e.g., sputtering), the resultant film has a high saturated magnetization but the film has a high coercitivity and a low resistivity, thus making it difficult to provide a favorable high-frequency characteristic.

On the other hand, a Co-base amorphous alloy has been known as material having a superior soft magnetic characteristic. The Co-base amorphous alloy is mostly amorphous material that contains Co as the major component and that includes one or more element(s) selected from the group of Y, Ti, Zr, Hf, Nb, Ta or the like. However, when a magnetic thin film of Co-base amorphous alloy of zero magnetostrictive composition is manufactured by a film formation technique (e.g., sputtering), the resultant film has a high magnetic permeability but has a saturated magnetization of about 1.1 T (11 kG), which is smaller than that of a Fe-base material. Furthermore, a loss component (imaginary part μ2 of magnetic permeability) when a frequency exceeds about 100MHz is increased to cause a quality factor Q value of one or less. Thus, the Co-base amorphous alloy is not suitable as a magnetic material used in a high-frequency band in a GHz band.

There has been an attempt to provide, in order to realize an inductor in a GHz band using the above material that is difficult to be used, a magnetic thin film by microwire to increase the shape anisotropy energy to increase the resonance frequency (e.g., see Journal of The Magnetic Society of Japan, 24, 879 (2000)). However, this method has a problem in that the process is complicated and the effective magnetic permeability of the thin film is lowered.

In view of the actual situation of the conventional technique, various suggestions have been made in order to improve the high-frequency characteristic of a soft magnetic thin film. The basic principles for the improvement of these suggestions include the suppression of eddy current loss and the increase in a resonance frequency, for example. Specific measures for suppressing the eddy current loss include, for example, multilayering by a layering of magnetic layer/insulating layer (high resistance layer) (e.g., Japanese Laid-Open Publication No. 7-24951 (see P. 1)) and granularization of metal-nonmetal (oxide, fluoride) (e.g., see J. Appl. Phys., 79, 5130 (1996)). However, these methods insert the non-magnetic phase having a high resistance, thus causing a problem that the saturated magnetization is lowered. A metal-nonmetal granular film also causes a problem that the magnetic permeability is low, equal to or less than 200.

On the other hand, a highly-saturated magnetization thin film also has been examined, which is obtained by a multilayer film by alternately layering a soft magnetic layer and a highly-saturated magnetization layer. Specifically, examples of various combinations have been reported, including: CoZr/Fe (e.g., see Journal of The Magnetic Society of Japan, 16, 285 (1992)); FeBN/FeN (e.g., see Japanese Laid-Open Publication No. 5-101930 (p. 1)); FeCrB/Fe (e.g., see Journal of The Magnetic Society of Japan, 16, 285 (1992)); and Fe—Hf—C/Fe (e.g., see Journal of The Magnetic Society of Japan, 15, 403 (1991)). Any of them is effective to increase the saturated magnetization but the magnetic permeability in a high-frequency band is not so high and thus they are not expected to be used in a GHz band application.

### DISCLOSURE OF THE INVENTION

There is a need for solving the above problems. The first objective is to provide a magnetic thin film for high frequencies that has a high magnetic permeability in a high-frequency region of a GHz band and that has a high saturated magnetization. The second objective of the present invention is to provide a method of manufacturing a magnetic thin film for high frequencies having the characteristic as described above. The third objective of the present invention is to provide a magnetic device using the magnetic thin film for high frequencies.

The magnetic thin film for high frequencies of the present invention for achieving the first objective has a DM (discontinuous multilayer) structure formed of ferromagnetic metal in amorphous state and amorphous metal different from the ferromagnetic metal.

Herein, the term “amorphous state” does not always mean only a complete amorphous state and includes all states other than a complete crystallization state. Specifically, non-crystallization state may be included with a level at which a diffraction peak due to an X-ray diffraction is not recognized. The wording “a level at which a diffraction peak is not recognized” means that a so-called sharp peak does not exist. This term “amorphous state” also includes “micro crystallite state” in which only partial crystallization is reached. The term “DM structure” means a structure that shows a discontinuous multilayer structure, that does not show a clear multilayer structure and each phase does not show a clear crystal phase, and that entirely shows amorphous state.

According to this invention, the magnetic thin film for high frequencies having a DM structure formed of ferromagnetic metal in amorphous state and amorphous metal different from the ferromagnetic metal does not show a structure showing a clear layered structure or a structure showing crystal phase. Thus, this structure shows a high magnetic permeability while maintaining a high saturated magnetization owned by a ferromagnetic material to show soft magnetism and has a high resistivity, for example. As a result, the magnetic thin film for high frequencies having the structure as described above has a superior quality factor Q (Q=μ1/μ2 and this applies to the performance indexes Q shown below) in a high-frequency region of a GHz band.

In the magnetic thin film for high frequencies of the present invention, it is preferable that (i) the ferromagnetic metal is predominantly composed of Fe or FeCo and contains one or more element(s) selected from the group of C, B, and N, and the amorphous metal is a Co-base amorphous alloy. The ferromagnetic metal as described above can include, for example, Fe—C. Furthermore, it is more preferable that (ii) the amorphous metal is CoZrNb.

As described in the above (i), when the ferromagnetic metal is Fe-base or FeCo-base alloy having a high saturated magnetization and the amorphous alloy is Co-base amorphous alloy as soft magnetic material, the resultant magnetic thin film for high frequencies shows a high magnetic permeability while maintaining a high saturated magnetization to show soft magnetism and shows a high resistivity, thus having a superior quality factor Q. In the case of the above (ii) in which the amorphous metal is CoZrNb in particular, a composition having a zero magnetostriction can be realized easily. Thus, an advantage is provided that the soft magnetic characteristic is superior and a high magnetic permeability is obtained.

In the magnetic thin film for high frequencies of the present invention, the ferromagnetic metal preferably has a film thickness equal to or less than 3.0 nm and more preferably in the range of 0.5 nm to 2.0 nm. The film thickness equal to or larger than 0.5 nm can provide an enough thickness of the whole layers easily. The film thickness equal to or less than 2.0 nm can increase an interface between the ferromagnetic metal and the amorphous metal. The term “film thickness” herein means the one obtained by a measurement when the measurement is possible and means, when the measurement is difficult, a calculated film thickness (estimated film thickness) that is obtained, for example, by calculation in which the ratio of layers of the ferromagnetic metal to layers of the amorphous metal is converted based on the total thickness, the total number of layers, and the film formation conditions.

In the magnetic thin film for high frequencies of the present invention, a ratio of a film thickness of the ferromagnetic metal to a film thickness of the amorphous metal is preferably in the range of 0.8 to 3.0 and more preferably in the range of 1.0 to 2.5.

In the magnetic thin film for high frequencies of the present invention, the ferromagnetic metal and the amorphous metal are preferably alternately layered in a repeated manner. In this case, the number of repetitions of layering the ferromagnetic metal and the amorphous metal are preferably in the range of 5 to 3000 and the total thickness of layered films is in the range of 100 nm to 2000 nm. More preferably, the number of repetitions of layering the ferromagnetic metal and the amorphous metal are in the range of 10 to 700 and the total thickness of layered films is in the range of 300 nm to 1000 nm.

The magnetic thin film for high frequencies of the present invention is preferably structured so that, for example, the real part (μ1) of the complex magnetic permeability at 1 GHz is 400 or more and the quality factor Q (Q=μ1/μ2) is 3 or more, and the saturated magnetization is 1.3 T (13 kG) or more and the resistivity is 100 μΩcm or more.

A method of manufacturing a magnetic thin film for high frequencies of the present invention for achieving the second objective is: a method of manufacturing a magnetic thin film for high frequencies having a DM structure formed of ferromagnetic metal and amorphous metal, including: a ferromagnetic metal deposition step of depositing the ferromagnetic metal so that amorphous state is maintained; and an amorphous metal deposition step of depositing amorphous metal different from the ferromagnetic metal, wherein the ferromagnetic metal deposition step and the amorphous metal deposition step are alternately performed a plurality of times to form the DM structure.

According to this invention, the DM structure is formed by alternately performing the ferromagnetic metal deposition step for depositing the ferromagnetic metal so that the amorphous state is maintained and the amorphous metal deposition step for depositing the amorphous metal different from the ferromagnetic metal. Thus, the formed magnetic thin film for high frequencies has the DM structure that does not show a clear layered structure or crystal phase. Therefore, this structure shows a high magnetic permeability while maintaining a high saturated magnetization owned by a ferromagnetic material to show soft magnetism and has a high resistivity, for example. As a result, the magnetic thin film for high frequencies having a superior quality factor Q in a high-frequency region of a GHz band can be manufactured.

In the method for manufacturing the magnetic thin film for high frequencies of the present invention, it is preferable that the ferromagnetic metal is predominantly composed of Fe or FeCo and contains one or more element(s) selected from the group of C, B, and N, and the amorphous metal is a Co-base amorphous alloy.

A magnetic device of the present invention for achieving the third objective has one or more a magnetic thin film for high frequencies, wherein the magnetic thin film for high frequencies has a DM structure formed of ferromagnetic metal in amorphous state and amorphous metal different from the ferromagnetic metal.

It is preferable that: (a) the magnetic device of the present invention further includes a coil and the magnetic thin film for high frequencies are provided to be opposed to each other so as to sandwich the coil; (b) the magnetic device is used for an inductor or a transformer; and (c) the magnetic device is used for a monolithic microwave integrated circuit.

As described above, the magnetic thin film for high frequencies of the present invention employs the DM structure formed of ferromagnetic metal in amorphous state and amorphous metal different from the ferromagnetic metal so as not to show a structure showing a clear layered structure or a structure showing crystal phase. Thus, this structure can show a high magnetic permeability while maintaining a high saturated magnetization owned by a ferromagnetic material to show soft magnetism and can secure a high resistivity. As a result, a superior quality factor Q in a high-frequency region of a GHz band can be realized for example. The magnetic thin film for high frequencies as described above can be preferably used, for example, as a magnetic thin film for high frequencies that is applied to an inductor having a flat type spiral coil provided on MMIC. The magnetic thin film for high frequencies of the present invention also can provide the function while being formed in a room temperature. Thus, this is an optimal material for a high-frequency integrated circuit manufactured in a semiconductor process (e.g., MMIC). The magnetic thin film for high frequencies of the present invention can be used in a frequency band equal to or higher than several hundreds MHz and particularly in a GHz frequency band equal to or higher than 1 GHz.

According to the method for manufacturing the magnetic thin film for high frequencies of the present invention, a magnetic thin film having a DM structure that does not show a structure showing a clear layered structure or a structure showing crystal phase can be formed by the simple method in which the ferromagnetic metal deposition step and the amorphous metal deposition step are alternately performed. Thus, a magnetic thin film for high frequencies having a superior quality factor Q in a high-frequency region of a GHz band can be manufactured easily.

The magnetic device of the present invention has the magnetic thin film for high frequencies having a superior quality factor Q. Thus, the magnetic device can be applied, for example, to an inductor, a transformer, or a monolithic microwave integrated circuit or the like, thereby providing a device having a superior high-frequency characteristic. For example, when the magnetic thin film for high frequencies is applied to a spiral coil in a planar type inductor provided on MMIC, the inductor functions, for example, as a magnetic device in which the eddy current loss at a GHz band is reduced.

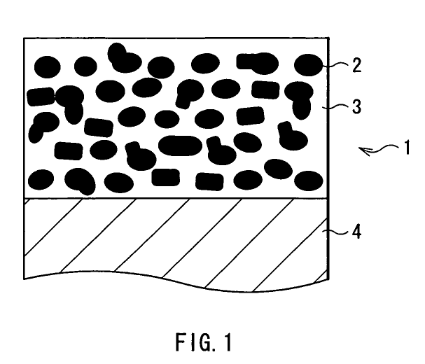

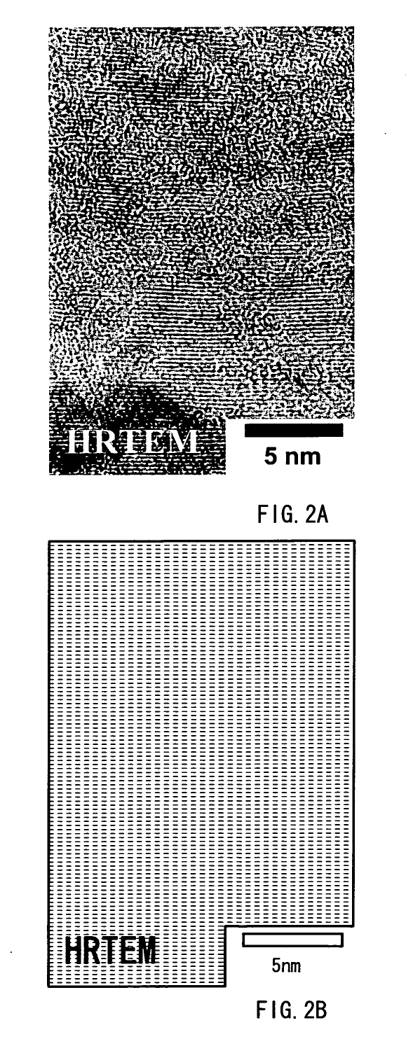

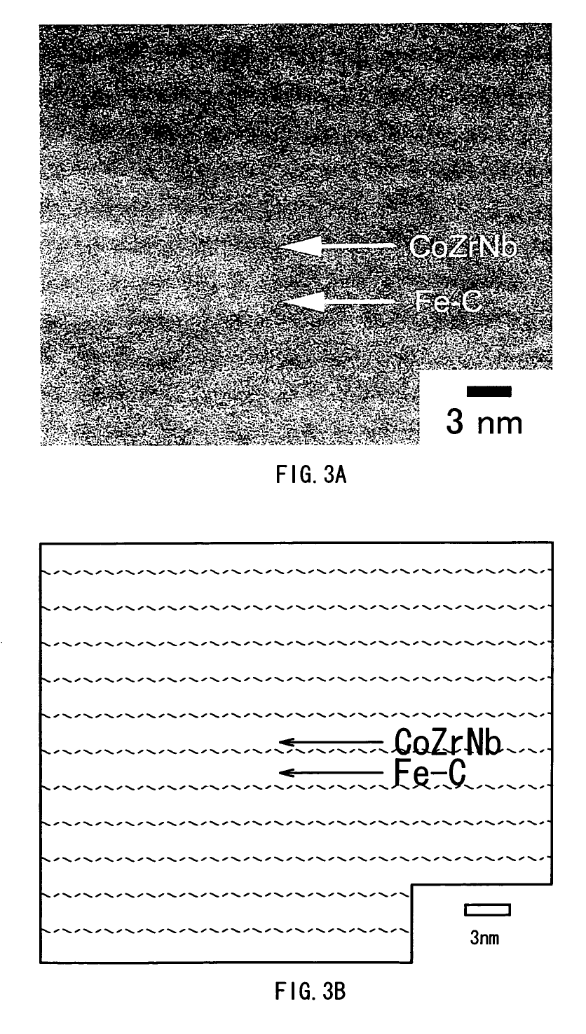

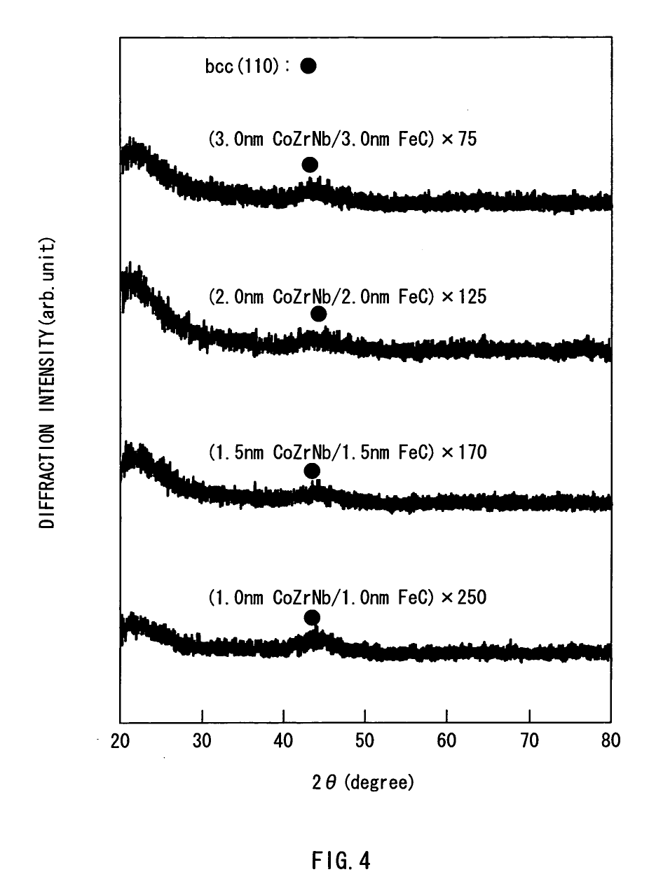

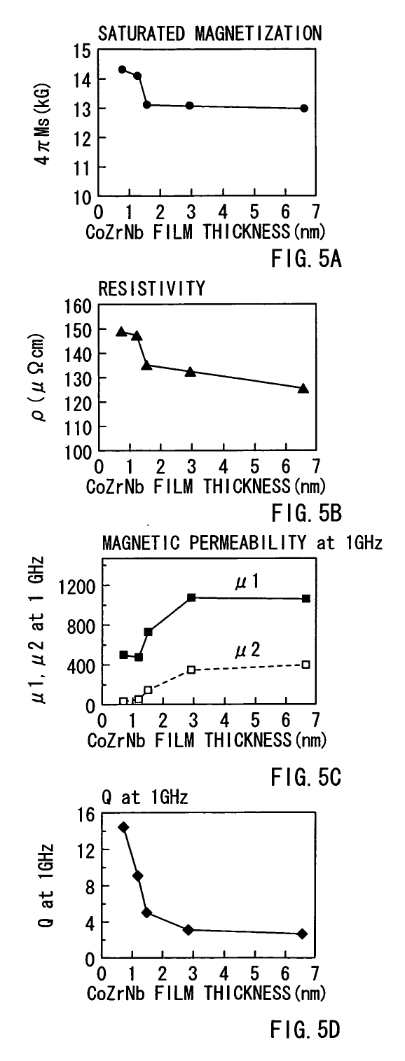

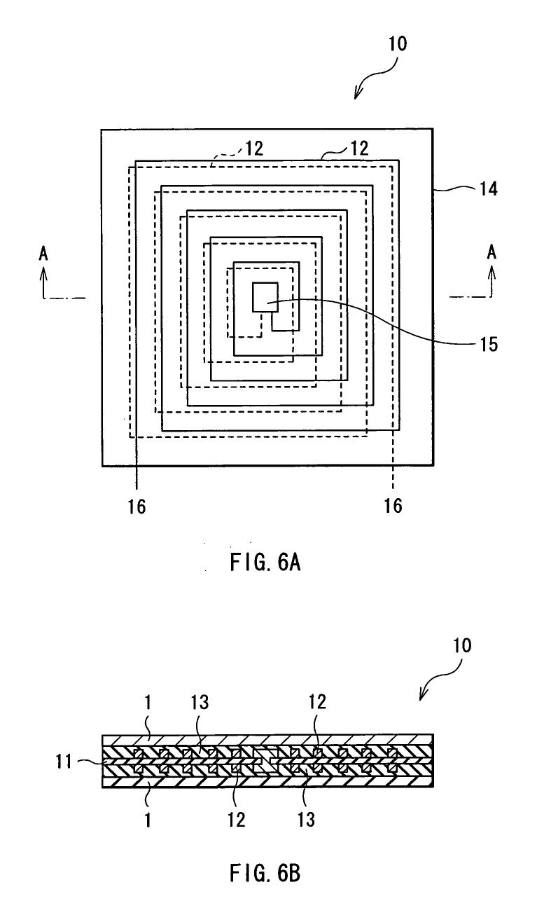

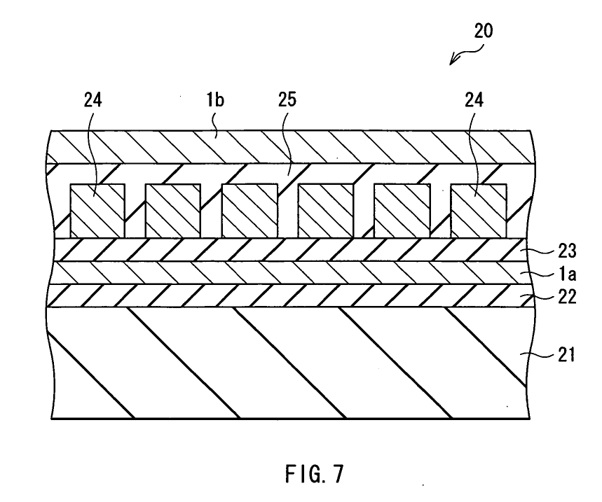

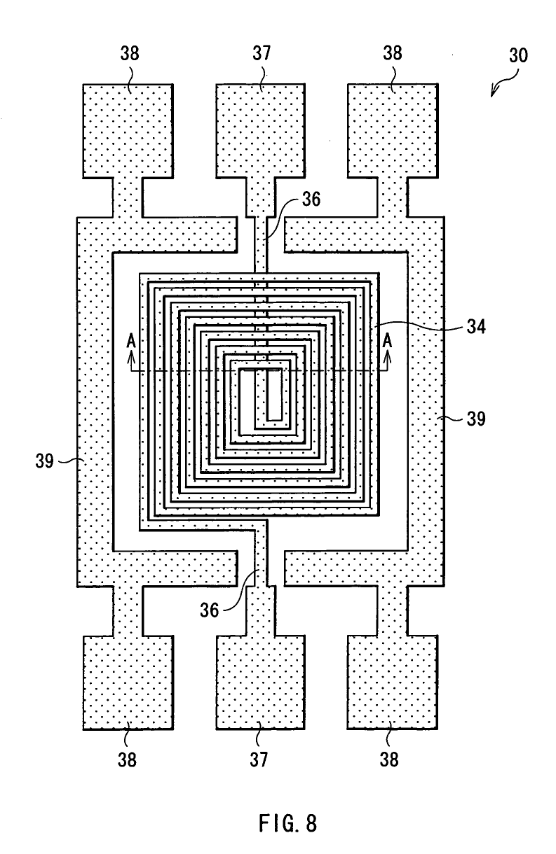

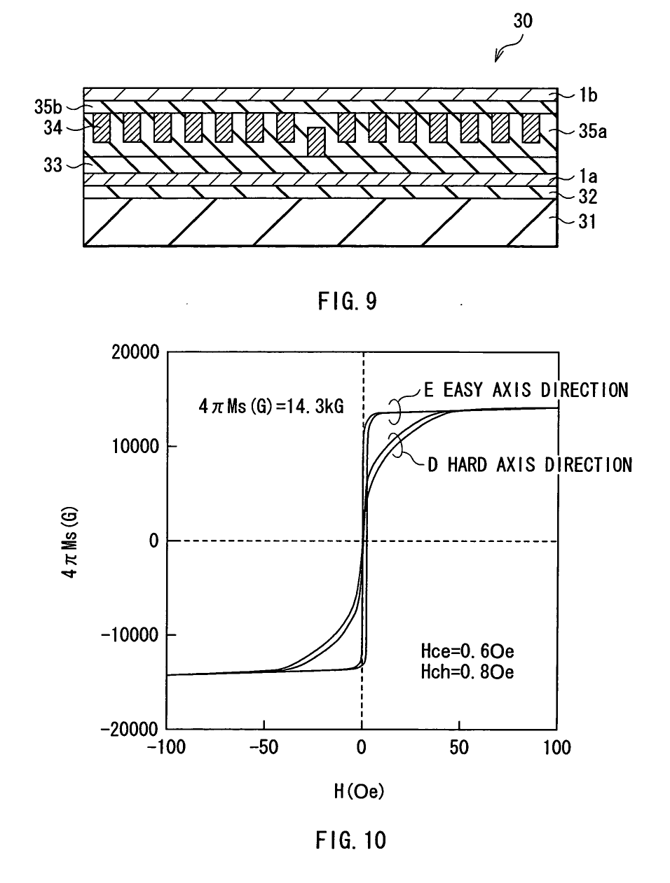

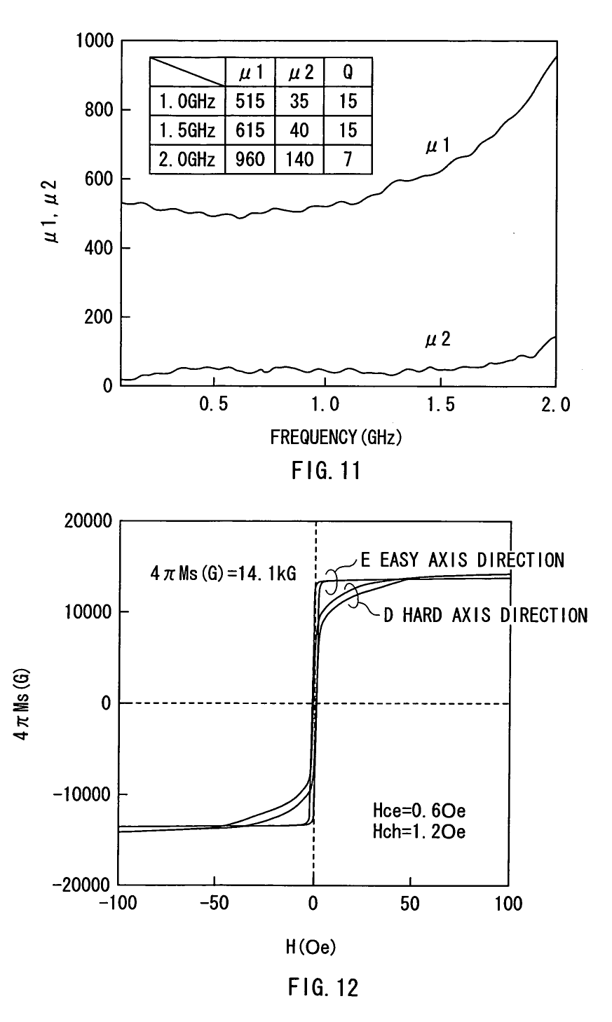

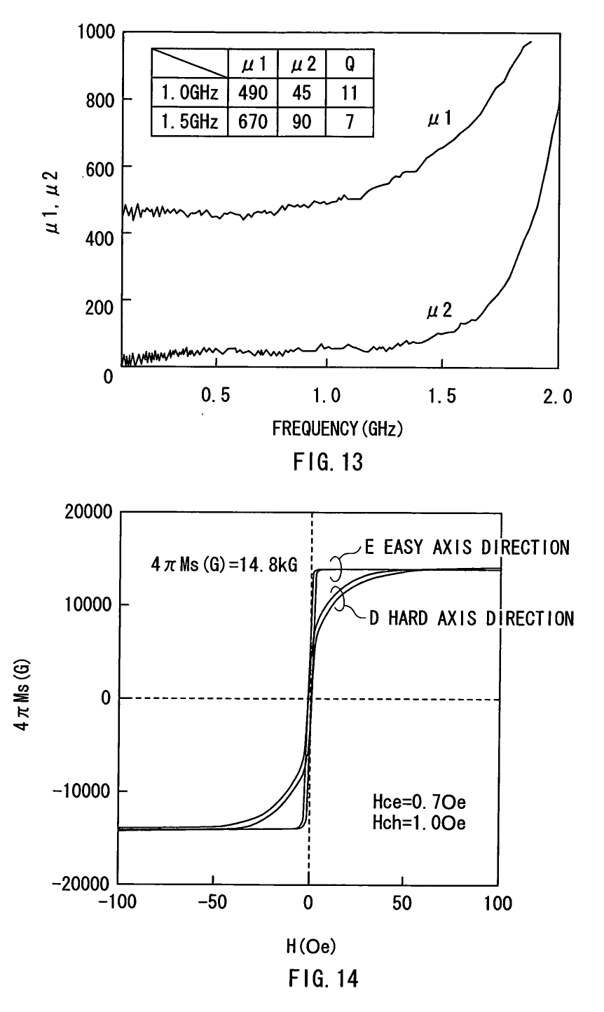

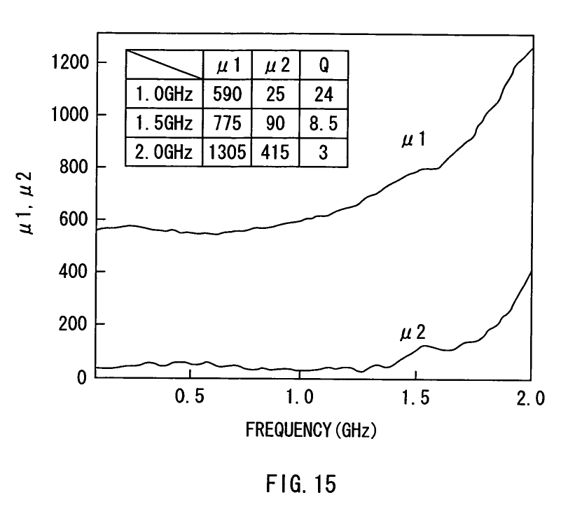

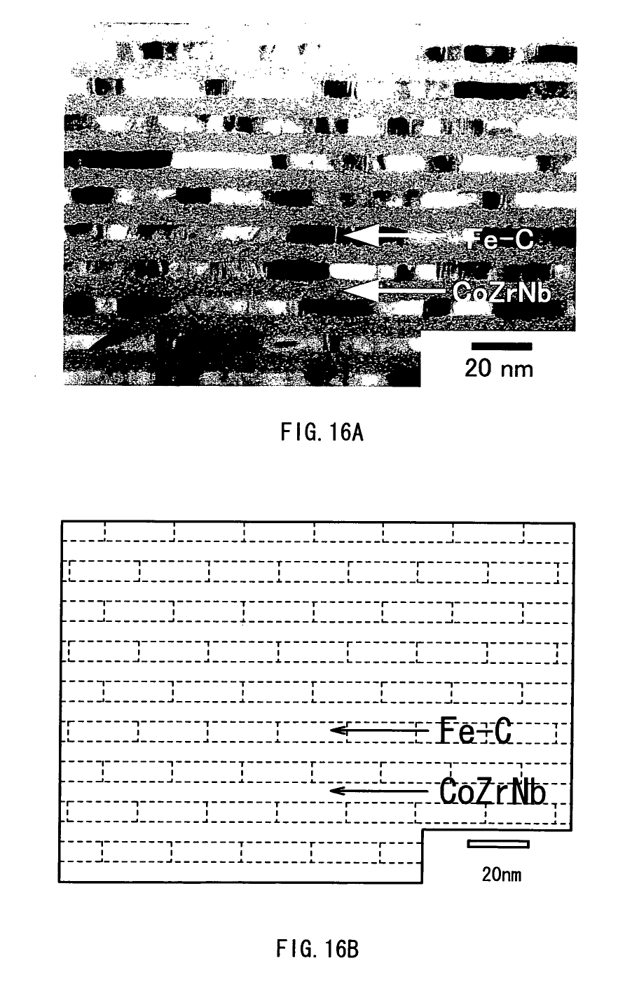

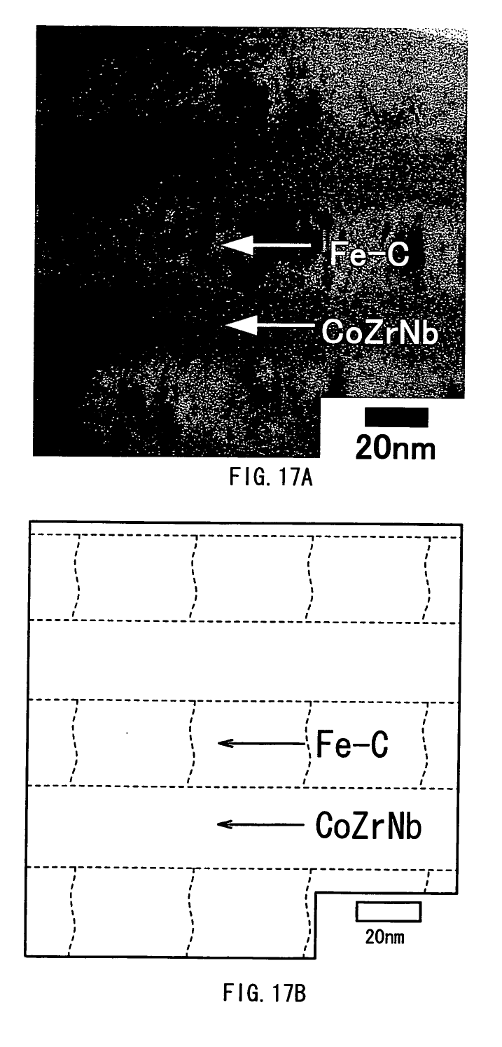

### BRIEF DESCRIPTION OF THE DRAWINGS

[FIG. 1] FIG. 1 is a schematic view illustrating an example of a cross section of a magnetic thin film for high frequencies of the present invention.

[FIG. 2A] FIG. 2A is a HRTEM photograph illustrating an example of a cross section of the magnetic thin film for high frequencies of the present invention.

[FIG. 2B] FIG. 2B is a schematic view illustrating the HRTEM photograph shown in FIG. 2A.

[FIG. 3A] FIG. 3A is a STEM photograph illustrating another example of a cross section of the magnetic thin film for high frequencies of the present invention.

[FIG. 3B] FIG. 3B is a schematic view illustrating the STEM photograph shown in FIG. 3A.

[FIG. 4] FIG. 4 illustrates an XRD pattern when the deposition film thicknesses of a ferromagnetic metal and an amorphous metal are changed.

[FIG. 5A] FIG. 5A is a graph illustrating the relation between the film thickness and the saturated magnetization in the magnetic thin film for high frequencies of the present invention.

[FIG. 5B] FIG. 5B is a graph illustrating the relation between the film thickness and the resistivity in the magnetic thin film for high frequencies of the present invention.

[FIG. 5C] FIG. 5C is a graph illustrating the relation between the film thickness and the magnetic permeability in the magnetic thin film for high frequencies of the present invention.

[FIG. 5D] FIG. 5D is a graph illustrating the relation between the film thickness and the quality factor Q in the magnetic thin film for high frequencies of the present invention.

[FIG. 6A] FIG. 6A illustrates an example in which a flat type magnetic device is applied to an inductor.

[FIG. 6B] FIG. 6B is a schematic view illustrating the cross section of FIG. 6A seen in the direction of A-A.

[FIG. 7] FIG. 7 is a schematic cross sectional view illustrating another example in which the flat type magnetic device of the present invention is applied to the inductor.

[FIG. 8] FIG. 8 is a schematic plan view illustrating a conductor layer part of the inductor.

[FIG. 9] FIG. 9 is a schematic view illustrating the cross section of FIG. 8 seen in the direction of A-A.

[FIG. 10] FIG. 10 shows a magnetization curve of a magnetic thin film manufactured in Example 1.

[FIG. 11] FIG. 11 is a graph illustrating a high-frequency magnetic permeability characteristic of the magnetic thin film manufactured in Example 1.

[FIG. 12] FIG. 12 illustrates a magnetization curve of a magnetic thin film manufactured in Example 2.

[FIG. 13] FIG. 13 is a graph illustrating a high-frequency magnetic permeability characteristic of the magnetic thin film manufactured in Example 2.

[FIG. 14] FIG. 14 illustrates a magnetization curve of a magnetic thin film manufactured in Example 3.

[FIG. 15] FIG. 15 is a graph illustrating a high-frequency magnetic permeability characteristic of the magnetic thin film manufactured in Example 3.

[FIG. 16A] FIG. 16A illustrates a TEM image of a magnetic thin film manufactured in Comparative Example 1.

[FIG. 16B] FIG. 16B is a schematic view of the TEM image shown in FIG. 16A.

[FIG. 17A] FIG. 17A illustrates a TEM image of a magnetic thin film manufactured in Comparative Example 2.

[FIG. 17B] FIG. 17B is a schematic view illustrating the TEM image shown in FIG. 17A.

### BEST MODE FOR CARRYING OUT THE INVENTION

Hereinafter, a magnetic thin film for high frequencies and a method of manufacturing the same and a magnetic device according to an embodiment of the present invention will be described with reference to the drawings. It is noted that the scope of the present invention is not limited by embodiments described below.

FIG. 1 is a schematic view illustrating an example of a cross section of a magnetic thin film for high frequencies of this embodiment. FIG. 2A and FIG. 2B illustrate High-resolution Transmission Electron Microscope (HRTEM) images illustrating an example of the cross section of this magnetic thin film for high frequencies. FIG. 3A and FIG. 3B illustrate Scanning Transmission Electron Microscope images (STEM image) illustrating another example of the cross section of this magnetic thin film for high frequencies.

As shown in FIG. 1 to FIG. 3A and FIG. 3B, the magnetic thin film for high frequencies 1 has a cross-sectional structure that is a DM structure by a ferromagnetic metal 2 and an amorphous metal 3. The DM structure herein is an abbreviation of a discontinuous multilayer and can be recognized, to be brief, as a discontinuous multilayer structure. The DM structure as described above is realized by controlling steps of manufacturing a multilayer film as described later in the section of the manufacturing method. Hereinafter, the structure of the magnetic thin film for high frequencies 1 will be described.

(Ferromagnetic Metal)

The ferromagnetic metal 2 includes one or more element(s) selected from the group of C, B, and N in Fe or FeCo as a ferromagnetic material.

One or more element(s) selected from the group of C, B, and N are preferably contained because it/they can improve the soft magnetic characteristic of Fe or FeCo that has a high saturated magnetization but has a high coercitivity and a relatively small resistivity. One or more element(s) selected from the group of C, B, and N is/are contained with the concentration generally in a range from 2 to 20 atomic percent (which is simply referred to as at %) and desirably in a range from 4 to 15 at %. When the concentration of the element(s) is smaller than 2 at %, the columnar crystal of the bcc structure tends to grow in a direction vertical to the substrate to increase the coercitivity and to reduce the resistivity, making it difficult to provide a favorable high frequency characteristic. When the concentration of the element(s) exceeds 20 at % on the other hand, then the anisotropic magnetic field is reduced to lower the resonance frequency, thus causing a difficulty in providing a function as a thin film for high frequencies. A particularly preferable case is the one in which C is contained and the concentration of C in this case is preferably in the range from 4 to 15 at %.

The use of FeCo is more desirable than the use of Fe because the former provides a higher saturated magnetization. The Co content in FeCo in this case may be appropriately determined within a range equal to or less than 80 at % and is desirably may be within a range from 20 to 50 at %. An element other than Fe and FeCo also may be contained in a range that has no adverse influence on the present invention.

(Amorphous Metal)

As the amorphous metal 3, Co-base amorphous alloy is preferably used. Co-base amorphous alloy has a high magnetic permeability and a high resistance (resistivity of 100 to 150 μΩcm) and thus is effective for suppressing the eddy current loss in a high-frequency area and is preferably used. Such Co-base amorphous alloy is desirable that has a characteristic having a single layer film, a magnetic permeability equal to or higher than 1000 (10 MHz), a saturated magnetization equal to or more than 1.0 T (10 kG), and a resistivity equal to or more than 100 μΩcm.

This embodiment uses amorphous metal as a material that is alternately deposited with the ferromagnetic metal 2. This can suppress the start of the crystal growth of the ferromagnetic metal to be deposited compared to a case where the material is crystalline metal.

This Co-base amorphous alloy has Co as the major component and is formed to contain at least one or more additive element(s) selected from the group of B, C, Si, Ti, V, Cr, Mn, Fe, Ni, Y, Zr, Nb, Mo, Hf, Ta, and W.

The ratio of additive element(s) (total amount in a case of two or more additive elements) is generally in a range from 5 to 50 at % and is preferably in a range from 10 to 30 at %. When the ratio of additive element(s) exceeds 50 at %, disadvantage is caused that the saturated magnetization is reduced. When the ratio of additive element(s) is equal to or less than 5 at %, disadvantage is caused that the control of magnetostriction is difficult, failing to provide an effective soft magnetic characteristic.

Co-base amorphous alloy includes, for example, CoZr, CoHf, CoNb, CoMo, CoZrNb, CoZrTa, CoFeZr, CoFeNb, CoTiNb, CoZrMo, CoFeB, CoZrNbMo, CoZrMoNi, CoFeZrB, CoFeSiB, and CoZrCrMo. In particular, CoZrNb is preferable.

(DM structure)

FIG. 2A and FIG. 2B are a HRTEM image illustrating a film cross section obtained by alternately depositing the ferromagnetic metal 2 having a film thickness of 1.0 nm of Fe—C (C content; about 10 at %) and the amorphous metal 3 having a film thickness of 0.7 nm of CoZrNb 250 times, respectively (total 500 depositions). FIG. 2A is a HRTEM photograph and FIG. 2B is a schematic view showing a HRTEM photograph. FIG. 3A and FIG. 3B are an STEM image illustrating a film cross section obtained by alternately depositing the ferromagnetic metal 2 having a film thickness of 2.0 nm of Fe—C (C content: about 10 at %) and the amorphous metal 3 having a film thickness of 0.7 nm of CoZrNb 250 times, respectively (total 500 depositions). FIG. 3A is an STEM photograph and FIG. 3B is a schematic view illustrating an STEM photograph.

As shown in FIG. 2A and FIG. 2B and FIG. 3A and FIG. 3B, in the magnetic thin film for high frequencies of this embodiment, the ferromagnetic metal 2 and the amorphous metal 3 have a DM structure. The DM structure is a discontinuous multilayer structure. As shown in FIG. 2A and FIG. 2B and FIG. 3A and FIG. 3B for example, the DM structure does not have a clear multilayer structure and each phase does not show a clear crystal phase and, as shown in FIG. 4 for example, the DM structure shows an amorphous state (including micro crystallite state) as can be seen from the XRD (X-ray diffraction) pattern when the deposition film thicknesses of the ferromagnetic metal 2 and the amorphous metal 3 are changed.

The DM structure as described above can be confirmed, for example, by observing halo peak showing the amorphous state in a diffraction pattern measured by the X-ray diffraction method (XRD method). In the measurement by the XRD method, halo peak is easily confirmed by measuring a point in the vicinity of 2θ=45 degrees at which diffraction from a crystal face (110) of Fe—C is caused. Another means for confirming the DM structure includes, for example, the observation of the HRTEM cross section as shown in FIG. 2A and FIG. 2B or the observation of the STEM cross section as shown in FIG. 3A and FIG. 3B. It is noted that, in these observations by a transmission electron microscope, the structure is easily confirmed by simultaneously performing the measurement of electron ray diffraction (Selected Area Electron Diffraction) in the preparation of the sample and measurement.

The reason why the ferromagnetic metal 2 constituting the DM structure shows an amorphous state in this embodiment is that the deposition of ferromagnetic metal is stopped before the crystal growth of the ferromagnetic metal is sufficiently achieved. The ferromagnetic metal 2 having the amorphous state as described above has a high magnetic permeability while maintaining a high saturated magnetization owned by a ferromagnetic material to show soft magnetism and shows a high resistivity, for example. As a result, a magnetic thin film for high frequencies having a superior quality factor Q in a high-frequency region of a GHz band can be manufactured.

It is noted that, the magnetic thin film for high frequencies of this embodiment also includes the one having a structure showing an amorphous state (including micro crystallite status) as in the case of the above when a DM structure film obtained by repeatedly depositing the ferromagnetic metal 2 and the amorphous metal 3 is subsequently subjected to a heat treatment.

(Formation of DM Structure)

The DM structure is formed by alternately performing a ferromagnetic metal deposition step for stopping the deposition of a ferromagnetic metal before the crystal growth of the ferromagnetic metal is sufficiently achieved; and an amorphous metal deposition step for depositing metal becoming an amorphous state on the ferromagnetic metal.

When the above steps are performed, attention must be paid to that the deposition of the ferromagnetic metal is stopped with a thickness before the crystal growth of the ferromagnetic metal is sufficiently achieved or that the deposition is performed to obtain a film thickness by which the structure having a micro crystallite state or an amorphous state as in the above case is maintained when the DM structure film obtained by repeatedly depositing the ferromagnetic metal and the amorphous metal is subsequently subject to a heat treatment. In this manner, the DM structure can be formed.

In a specific example, as shown in FIG. 2A and FIG. 2B, the DM structure having an amorphous state can be provided by depositing Fe—C to have a film thickness of about 1.0 nm and depositing CoZrNb to have a film thickness of about 0.7 nm. The DM structure having an amorphous state also can be provided by depositing, as shown in FIG. 3A and FIG. 3B, Fe—C to have a film thickness of about 2.0 nm and by depositing CoZrNb to have a film thickness of about 0.7 nm.

The ferromagnetic metal that can have a DM structure having an amorphous state is deposited to have a film thickness equal to or less than 3.0 nm and is more preferably deposited to have a film thickness of 0.5 to 2.0 nm. When the ferromagnetic metal is deposited with a film thickness exceeding 3 nm, the crystal growth may be caused, which causes the reduction in the magnetic permeability and the reduction in the resistivity, causing the quality factor Q as a high-frequency characteristic in a GHz band to show an insufficient value.

On the other hand, an amorphous metal has no particular limitation in this respect because it generally has an amorphous state. However, from the viewpoint of a high-frequency characteristic in a GHz band as an objective of the present invention, an excessively high deposition film thickness is not preferable. The amorphous metal 3 is deposited to have a film thickness of [ferromagnetic metal deposition film thickness: T1]/[amorphous metal deposition film thickness: T2] of 0.8 to 3.0 and preferably of 1.0 to 2.5. By adjusting the deposition film thickness of amorphous metal so that the thickness is within the above ranges, a magnetic thin film not damaging the high-frequency characteristic can be obtained. When T1/T2l exceeds 3.0, particles of ferromagnetic metal such as Fe—C grow, which may cause a case where a high resistivity (e.g., 130 μΩcm or more) may not be obtained. When T1/T2 is less than 0.8, the ratio of ferromagnetic metal having a high saturated magnetization is lowered, thus making it difficult to increase the resonance frequency.

Next, the number of deposition times and thickness of ferromagnetic metal and amorphous metal will be described. Although the total number of deposition times when ferromagnetic metal and amorphous metal are alternately deposited is not particularly limited, the total number of deposition times is generally 5 to 3000 and is preferably 10 to 700. The final thickness of the magnetic thin film for high frequencies is 100 to 2000 nm and is preferably 300 to 1000 nm. When the thickness is less than 100 nm, a disadvantage may be caused that the resultant deposited material applied to a flat type magnetic device has a difficulty in handling a desired power. When the thickness exceeds 2000 nm on the other hand, a disadvantage may be caused that the high-frequency loss in a GHz band due to a skin effect increases.

Next, a method of manufacturing the magnetic thin film for high frequencies, that is, method of forming a DM structure, will be described. The magnetic thin film for high frequencies 1 is preferably formed by a vacuum thin film formation method, particularly sputtering method. More specifically, the sputtering method includes: RF sputtering, DC sputtering, magnetron sputtering, ion beam sputtering, inductive coupling RF plasma-assisted sputtering, ECR sputtering, and facing targets sputtering. The above sputtering is a mere example of the embodiment and other processes for preparing a thin film also may be used.

A target for depositing a ferromagnetic metal may be a composite target in which an Fe target or an FeCo target has thereon a pellet of one or more elements selected from C, B, and N or an alloy target in which one or more elements selected from Fe or FeCo and C, B, and N. The concentration of one or more elements selected from the group of C, B, and N may be adjusted, for example, by adjusting the amount of each element pellet.

A target for depositing a Co-base amorphous alloy may be a composite target in which a Co target has thereon a pellet of a desired additive element or a target of Co alloy containing a desired additive component.

A substrate 4 (see FIG. 1) on which the magnetic thin film for high frequencies 1 of this embodiment is formed can include a glass substrate, a ceramics material substrate, a semiconductor substrate, or a resin substrate. Ceramics material can include alumina, zirconia, silicon carbide, silicon nitride, aluminum nitride, steatite, mullite, cordierite, forsterite, spinel, or ferrite. Among them, aluminum nitride having a high thermal conductivity and a high bending strength is preferable. The magnetic thin film for high frequencies of this embodiment can provide the function while being formed in a room temperature (about 15 to 35 degrees). Thus, the magnetic thin film for high frequencies of this embodiment is suitable for a high-frequency integrated circuit such as MMIC that is manufactured in a semiconductor process. Therefore, substrates can include semiconductor substrates such as Si, GaAs, InP, and SiGe, for example.

(High-frequency Characteristic of Magnetic Thin Film)

FIG. 5A to FIG. 5D are graph illustrating an example of the relation between the film thickness of the magnetic thin film for high frequencies of this embodiment and a saturated magnetization of 4πMs (FIG. 5A), resistivity ρ (FIG. 5B), magnetic permeabilities μ1 and μ2 (FIG. 5C), and quality factor Q (FIG. 5D). This relation shows the respective characteristics when the film thickness of CoZrNb is changed in a range from 0.5 to 6.5 nm when amorphous metal of CoZrNb is used, ferromagnetic metal of Fe—C is used, and [film thickness of CoZrNb]/[film thickness of Fe—C] is 0.7.

As shown in FIG. 5A to FIG. 5D, when the film thickness of CoZrNb is equal to or less than 1.5 nm in this system, an increase in the saturated magnetization (see FIG. 5A) and an increase in the resistivity (see FIG. 5B) are strongly shown. In this system, the magnetic permeability is increased when the film thickness of CoZrNb is equal to or more than 3 nm. However, the loss (μ2) is also increased (see FIG. 5C). Thus, it is clear that a high Q value can be obtained when the film thickness of CoZrNb is equal to or less than 1.5 nm (see FIG. 5D). A structure when each layer has a film thickness equal to or less then 3 nm (preferably equal to or less than 2 nm) has a so-called DM structure, as can be seen from the results of TEM images of FIG. 2A and FIG. 2B to FIG. 4 and the result of XRD.

The magnetic thin film for high frequencies of this embodiment has the above-described DM structure. Thus, the real part (μ1) of the complex magnetic permeability at 1 GHz is 400 or more, the quality factor Q is 3 or more, the saturated magnetization is 1.3 T (13 kG) or more, and the resistivity is 100 μΩcm. It is noted that the real part (μ1) of the magnetic permeability in a GHz region (1 GHz) desirably has a value as high as possible and has no particular upper limit. Similarly, the saturated magnetization also desirably has a value as high as possible and has no particular upper limit. The characteristic as described above is measured during the film formation without a heat treatment or the like.

(Magnetic Device)

The magnetic device of this embodiment is partially includes the above-described magnetic thin film for high frequencies.

FIG. 6A and FIG. 6B illustrate an example in which a flat type magnetic device is applied to an inductor. FIG. 6A is a plan view schematically showing an inductor. FIG. 6B is a schematic view of the cross section of FIG. 6A seen in the direction of A-A.

An inductor 10 shown in these drawings includes: a substrate 11; flat coils 12 formed in a spiral manner on both faces of the substrate 11; insulating films 13 formed to cover the flat coils 12 and the face of a substrate 11; and a pair of magnetic thin film for high frequencies 1 formed to cover thee insulating films 13. The magnetic thin film for high frequencies 1 have the same structure as that shown in FIG. 1. The above two flat coils 12 are electrically connected via a through hole 15 formed at the substantially center of the substrate 11. Furthermore, from the flat coils 12 at both faces of the substrate 11, terminals 16 for connection are drawn out to outside of the substrate 11. The inductor 10 as described above is structured to sandwich, by the pair of magnetic thin film for high frequencies 1, the flat coils 12 via the insulating films 13, thus allowing the connection terminals 16 to have therebetween an inductor.

The inductor as described above has a small size, a thin thickness, and a light weight and shows a superior inductance particularly in a high-frequency band equal to or higher than 1 GHz. It is noted that, in the above-mentioned inductor 10, a plurality of flat coils 12 can be provided in parallel to form a transformer.

FIG. 7 is a schematic cross sectional view illustrating another example in which the flat type magnetic device of this embodiment is applied to an inductor.

An inductor 20 shown in FIG. 7 includes: a substrate 21; an oxide film 22 optionally formed on the substrate 21; a magnetic thin film for high frequencies 1a formed on the oxide film 22; and an insulating film 23 formed on the magnetic thin film for high frequencies 1a. The 20 further has: a flat coil 24 formed on the insulating film 23; an insulating film 25 formed to cover the flat coil 24 and the insulating film 23; and a magnetic thin film for high frequencies 1b formed on the insulating film 25. The magnetic thin film for high frequencies 1a and 1bhave the same structure as that of the above-described magnetic thin film for high frequencies 1 (FIG. 1). The inductor 20 thus formed also has a small size, a thin thickness, and a light weight and shows a superior inductance particularly in a high-frequency band equal to or higher than 1 GHz. In the inductor 20 as described above, the plurality of flat coils 24 can be provided in parallel, thereby providing a transformer.

FIG. 8 and FIG. 9 illustrate an example in which the magnetic thin film for high frequencies 1 of this embodiment is used as an inductor for MMIC. FIG. 8 is a plan view schematically illustrating the conductor layer part of the inductor. FIG. 9 is a schematic view illustrating the cross section of FIG. 8 seen in the direction of A-A.

The inductor 30 shown in these drawings include: a substrate 31; an insulating oxide film 32 optionally formed on the substrate 31; the magnetic thin film for high frequencies 1a formed on the insulating oxide film 32; and an insulating film 33 formed on the magnetic thin film for high frequencies 1a. The inductor 30 also has: a spiral coil 34 formed on the insulating film 33; insulating films 35a and 35b formed to cover the spiral coil 34 and the insulating film 33; and the magnetic thin film for high frequencies 1b formed on the insulating film 35b. The magnetic thin film for high frequencies 1a and 1b have the same structure as that of the above-described magnetic thin film for high frequencies 1 (FIG. 1).

The spiral coil 34 is connected to a pair of electrodes 37 via a wiring 36. A pair of ground patterns 39 formed to surround the spiral coil 34 are connected to a pair of ground electrodes 38, respectively, and has a shape that uses a probe of ground-signal-ground (G-S-G) type to evaluate the frequency characteristic on a wafer.

The MMIC inductor according to the shape of this embodiment has a core structure in which the magnetic thin film for high frequencies 1a and 1b as a magnetic core sandwich the spiral coil 34. This structure improves the inductance value by about 50% when compared with a case of an air-core structure in which, although the spiral coil 34 has the same shape, the magnetic thin film for high frequencies 1a and 1b are not formed. Thus, an area occupied by the spiral coil 34 that is required for obtaining the same inductance value may be smaller, consequently realizing the spiral coil 34 having a smaller size.

By the way, materials for a magnetic thin film used for a MMIC inductor are required, for example, to have a high magnetic permeability and a high quality factor Q (low loss) characteristic in a high-frequency region of a GHz band and to be able to be integrated by a process for manufacturing semiconductor.

In order to realize a high magnetic permeability in a high-frequency region of a GHz band, material having a high resonance frequency and a high saturated magnetization is advantageous, thus requiring the control of the uniaxial magnetic anisotropy. In order to obtain a high quality factor Q, the suppression of the eddy current loss due to a high resistance is important. Furthermore, in order to allow material to be applied to an integration process, the material can be desirably used for a film formation at a room temperature and can be used in the state during the film formation. This is for the purpose of preventing an adverse influence on the performance and preparation process of other on-chip components that are already set.

### EXAMPLES

Hereinafter, the magnetic thin film for high frequencies of this embodiment will be described further in detail with reference to Examples and Comparative Examples.

### Example 1

A magnetic thin film for high frequencies of Example 1 was manufactured in accordance with a film formation method as described below.

First, a substrate obtained by forming a film of SiO₂ to have a thickness of 500 nm on a Si wafer was used. Next, a facing targets type sputtering apparatus was used to deposit a magnetic thin film for high frequencies on the substrate by the procedure as described below. Specifically, the space in the facing targets type sputtering apparatus was subjected to a preliminary evacuation until 8×10⁻⁵ Pa was reached to subsequently introduce Ar gas into the space until the pressure of 10Pa was reached. Then, the substrate surface was subjected to sputtering and etching for 10 minutes with RF power of 100 W. Next, the flow rate of Ar gas was adjusted to provide the pressure of 0.4 Pa to sequentially and alternately sputter a Co₈₇Zr₅Nb₈ target and a composite target in which an Fe target has thereon a C (carbon) pellet with a power of 300 W in a repeated manner. Thus, a magnetic thin film as a magnetic thin film for high frequencies having a specification as described later was deposited. The reason why the target having the composition of Co₈₇Zr₅Nb₈ was used is that this composition has almost zero magnetostriction and thus can realize a high magnetic permeability.

When the film was formed, the substrate was applied with a DC bias of −40 to −80 V. In order to prevent the influence by impurities on the target surface, a pre-sputtering was performed for ten minutes or more while a shutter being closed. Thereafter, the shutter was opened to form the film on the substrate. The film formation rate was 0.33 nm/second in the deposition of CoZrNb of amorphous metal and was 0.27 nm/second in the deposition of Fe—C of ferromagnetic metal. By controlling the time during which the shutter was closed or opened, the film thicknesses of the respective materials alternately deposited were adjusted. First, CoZrNb was deposited on the substrate to subsequently deposit Fe—C thereon. Thereafter, CoZrNb and Fe—C were sequentially and alternately deposited in the same manner.

Based on the film formation method as described above, a film of CoZrNb having a film thickness of 1.0 nm and a film of Fe—C (carbon concentration: 10 at %) having a film thickness of 1.0 nm were sequentially and alternately deposited 250 times, respectively, thereby forming the magnetic thin film (Example 1) of this embodiment having the total film thickness of 500 nm (corresponding to the total of 500 layers).

Although the substrate temperature was not controlled during the film formation, the substrate temperature increased to 30 degrees while the total film thickness reached 500 nm.

The structure of the magnetic thin film showed the DM structure in which both of Fe—C and CoZrNb were amorphous.

FIG. 10 illustrates a magnetization curve measured after the film formation. In FIG. 10, a reference numeral E denotes a magnetization curve in a direction of an axis of easy magnetization and a reference numeral D denotes a magnetization curve in a direction of an axis of hard magnetization. As can be seen from these magnetization curves, the deposited film shows an in-plane uniaxial magnetic anisotropy and the saturated magnetization was 1.43 T (14.3 kG), a coercitivity Hce in a direction of the axis of easy magnetization was 47.75 A/m (0.6 Oe), and a coercitivity Hch in a direction of the axis of hard magnetization was 63.66 A/m (0.80 Oe). FIG. 11 shows a high-frequency magnetic permeability characteristic of the deposited film of this example. As can be seen from this graph, the resonance frequency exceeds the measuring limit of 2 GHz and the real part of the magnetic permeability (μ1) in a GHz region is equal to or higher than 500. This graph also shows that the quality factor Q (Q=μ1/μ2) is 15 at 1 GHz and is 7 at 2 GHz. The measurement of the high-frequency magnetic permeability was performed by using a thin film high-frequency magnetic permeability measurement apparatus (Naruse Kagaku Kiki, PHF-F1000) and the magnetic characteristic was measured by a vibrating sample magnetometer (Riken Denshi. Co., Ltd, BHV-35).

### Example 2

Base on the film formation method of the above Example 1, a film of CoZrNb having a thickness of 0.9 nm and a film of Fe—C (carbon concentration: 10 at %) having a thickness of 1.3 nm were sequentially and alternately deposited 200 times, respectively, thereby forming a magnetic thin film of this embodiment (Example 2) having the total film thickness of 440 nm (corresponding to the total of 400 layers).

FIG. 12 illustrates a magnetization curve measured after the film formation. The reference numerals E and D denote the same meanings as those of FIG. 10. As magnetic characteristics calculated from these magnetization curves, the saturated magnetization was 1.41 T (14.1 kG), the coercitivity Hce in the direction of the axis of easy magnetization was 47.75 A/m (0.6 Oe), and the coercitivity Hch in the direction of the axis of hard magnetization was 95.50 A/m (1.2 Oe). FIG. 13 illustrates a high-frequency magnetic permeability characteristic of the deposited film of this example. As can be seen from this graph, the real part (μ1) of the magnetic permeability was 490 at 1.0 GHz and was 670 at 1.5 GHz. This graph also showed that the quality factor Q (Q=μ1/μ2) was 11 at 1.0 GHz and was 7 at 1.5 GHz.

### Example 3

Base on the film formation method of the above Example 1, a film of CoZrNb having a thickness of 1.0 nm and a film of Fe—C (carbon concentration: 10 at %) having a thickness of 2.0 nm were sequentially and alternately deposited 170 times, respectively, thereby forming a magnetic thin film of this embodiment (Example 3) having the total film thickness of 510 nm (corresponding to the total of 340 layers).

The magnetic thin film showed a DM structure in which both Fe—C and CoZrNb were amorphous.

FIG. 14 illustrates a magnetization curve measured after the film formation. The reference numerals E and D denote the same meanings as those of FIG. 10. As magnetic characteristics calculated from these magnetization curves, the saturated magnetization was 1.48 T (14.8 kG), the coercitivity Hce in the direction of the axis of easy magnetization was 55.70 A/m (0.7 Oe), and the coercitivity Hch in the direction of the axis of hard magnetization was 79.58 A/m (1.0 Oe). FIG. 15 illustrates a high-frequency magnetic permeability characteristic of the deposited film of this example. As can be seen from this graph, the resonance frequency exceeds the measuring limit of 2 GHz and the real part (μ1) of the magnetic permeability in a GHz region was equal to or higher than 500. This graph also showed that the quality factor Q (Q=μ1/μ2) was 8.5 at 1.5 GHz and was 3 at 2 GHz.

### Example 4

Base on the film formation method of the above Example 1, a film of CoZrNb having a thickness of 1.0 nm and a film of Fe—C (carbon concentration: 10 at %) having a thickness of 2.8 nm were sequentially and alternately deposited 135 times, respectively, thereby forming a magnetic thin film of this embodiment (Example 4) having the total film thickness of 513 nm (corresponding to the total of 270 layers).

The magnetic thin film showed a DM structure in which both Fe—C and CoZrNb were amorphous.

The property value of the magnetic thin film was calculated based on the method according to the above example. The result showed saturated magnetization of 1.50 T (15.0 kG) and the coercitivity in a direction of an axis of easy magnetization of 63.66 A/m (0.8 Oe) and the coercitivity in a direction of an axis of hard magnetization of 71.62 A/m (0.9 Oe), respectively. The real part (μ1) of the magnetic permeability at 1 GHz was 550 and the quality factor Q (Q=μ1/μ2) at 1 GHz was 22.

### Example 5

Base on the film formation method of the above Example 1, a film of CoZrNb having a thickness of 0.8 nm and a film of Fe—C (carbon concentration: 10 at %) having a thickness of 2.8 nm were sequentially and alternately deposited 140 times, respectively, thereby forming a magnetic thin film of this embodiment (Example 5) having the total film thickness of 504 nm (corresponding to the total of 280 layers).

The magnetic thin film showed a DM structure in which both Fe—C and CoZrNb were amorphous.

The property value of the magnetic thin film was calculated based on the method according to the above example. The result showed saturated magnetization of 1.58 T (15.8 kG) and the coercitivity in a direction of an axis of easy magnetization of 71.62 A/m (0.9 Oe) and the coercitivity in a direction of an axis of hard magnetization of 87.54 A/m (1.1 Oe), respectively. The real part (μ1) of the magnetic permeability at 1 GHz was 400 and the quality factor Q (Q=μ1/μ2) at 1 GHz was 16.

### Example 6

Base on the film formation method of the above Example 1, a film of CoZrNb having a thickness of 2.0 nm and a film of Fe—C (carbon concentration: 10 at %) having a thickness of 1.0 nm were sequentially and alternately deposited 170 times, respectively, thereby forming a magnetic thin film of this embodiment (Example 6) having the total film thickness of 510 nm (corresponding to the total of 340 layers).

The magnetic thin film showed a DM structure in which both Fe—C and CoZrNb were amorphous.

The property value of the magnetic thin film was calculated based on the method according to the above example. The result showed saturated magnetization of 1.39 T (13.9 kG) and the coercitivity in a direction of an axis of easy magnetization of 47.75 A/m (0.6 Oe) and the coercitivity in a direction of an axis of hard magnetization of 55.70 A/m (0.7 Oe), respectively. The real part (μ1) of the magnetic permeability at 1 GHz was 755 and the quality factor Q (Q=μ1/μ2) at 1 GHz was 6.

### Comparative Example 1

Base on the film formation method of the above Example 1, a film of CoZrNb having a thickness of 6.0 nm and a film of Fe—C (carbon concentration: 10 at %) having a thickness of 7.0 nm were sequentially and alternately deposited 30 times, respectively, thereby forming a magnetic thin film of Comparative Example 1 having the total film thickness of 390 nm (corresponding to the total of 60 layers).

The magnetic thin film showed a structure in which, as shown in a TEM image of FIG. 16A and the schematic view thereof of FIG. 16B, CoZrNb was amorphous and Fe—C was crystalline.

The property value of the magnetic thin film was calculated based on the method according to the above example. The result showed saturated magnetization of 1.30 T (13.0 kG) and the coercitivity in a direction of an axis of easy magnetization of 47.74 A/m (0.6 Oe) and the coercitivity in a direction of an axis of hard magnetization of 286.45 A/m (3.6 Oe), respectively. The real part (μ1) of the magnetic permeability at 1 GHz was 1050 and the quality factor Q (Q=μ1/μ2) at 1 GHz was 2.6.

### Comparative Example 2

Base on the film formation method of the above Example 1, a film of CoZrNb having a thickness of 20 nm and a film of Fe—C (carbon concentration: 10 at %) having a thickness of 30 nm were sequentially and alternately deposited 10 times, respectively, thereby forming a magnetic thin film of Comparative Example 2 having the total film thickness of 500 nm (corresponding to the total of 20 layers).

The magnetic thin film showed a structure in which, as shown in a TEM image of FIG. 17A and the schematic view of FIG. 17B, CoZrNb was amorphous and Fe—C was crystalline.

The property value of the magnetic thin film was calculated based on the method according to the above example. The result showed saturated magnetization of 1.69 T (16.9 kG) and the coercitivity in a direction of an axis of easy magnetization of 119.35 A/m (1.5 Oe) and the coercitivity in a direction of an axis of hard magnetization of 47.74 A/m (0.6 Oe), respectively. The real part (μ1) of the magnetic permeability at 1 GHz was 505 and the quality factor Q (Q=μ1/μ2) at 1 GHz was 6.

### Comparative Example 3

A magnetic thin film of Comparative Example 3 was formed in the same manner as that of the above Example 1 except for that Fe—C was changed to Fe.

The property value of the magnetic thin film was calculated based on the method according to the above example. The result showed saturated magnetization of 2.07 T (20.7 kG) and the coercitivity in a direction of an axis of easy magnetization of 334.23 A/m (4.2 Oe) and the coercitivity in a direction of an axis of hard magnetization of 1511.97 A/m (19.0 Oe), respectively. Although the real part (μ1) of the magnetic permeability at 1 GHz was 150, the magnetic permeability had a small value and thus the actual measurement value of μ2 had no reliability, thus failing to calculate the quality factor Q (Q=μ1/μ2).

### Example 7

A magnetic thin film of this example (Example 7) was formed in the same manner as that of the above Example 1 except for that the carbon concentration of Fe—C was changed from 10 at % to 12 at %.

The property value of the magnetic thin film was calculated based on the method according to the above example. The result showed saturated magnetization of 1.41 T (14.1 kG) and the coercitivity in a direction of an axis of easy magnetization of 47.75 A/m (0.6 Oe) and the coercitivity in a direction of an axis of hard magnetization of 55.76 A/m (0.7 Oe), respectively. The real part (μ1) of the magnetic permeability at 1 GHz was 600 and the quality factor Q (Q=μ1/μ2) at 1 GHz was 12.

### Example 8

A magnetic thin film of this example (Example 8) was formed in the same manner as that of the above Example 1 except for that the carbon concentration of Fe—C was changed from 10 at % to 15 at %.

The property value of the magnetic thin film was calculated based on the method according to the above example. The result showed saturated magnetization of 1.40 T (14.0 kG) and the coercitivity in a direction of an axis of easy magnetization of 47.75 A/m (0.6 Oe), and the coercitivity in a direction of an axis of hard magnetization of 55.76 A/m (0.7 Oe), respectively. The real part (μ1) of the magnetic permeability at 1 GHz was 750 and the quality factor Q (Q=μ1/μ2) at 1 GHz was 12.

### Example 9

A magnetic thin film of this example (Example 9) was formed in the same manner as that of the above Example 1 except for that Cos₈₇ Zr5Nb₈ as the composition of Co-base amorphous alloy was changed to Co89Zr6Ta5.

The property value of the magnetic thin film was calculated based on the method according to the above example. The result showed saturated magnetization of 1.44 T (14.4 kG) and the coercitivity in a direction of an axis of easy magnetization of 47.75 A/m (0.6 Oe), and the coercitivity in a direction of an axis of hard magnetization of 55.76 A/m (0.7 Oe), respectively. The real part (μ1) of the magnetic permeability at 1 GHz was 520 and the quality factor Q (Q=μ1/μ2) at 1 GHz was 15.

### Example 10

A magnetic thin film of this example (Example 10) was formed in the same manner as that of the above Example 1 except for that Co₈₇Zr₅Nb8 as the composition of Co-base amorphous alloy was changed to C0₈₀Fe₉Zr₃B₈.

The property value of the magnetic thin film was calculated based on the method according to the above example. The result showed saturated magnetization of 15.0 T (1.50 kG) and the coercitivity in a direction of an axis of easy magnetization of 47.75 A/m (0.6 Oe), and the coercitivity in a direction of an axis of hard magnetization of 55.76 A/m (0.7 Oe), respectively. The real part (μ1) of the magnetic permeability at 1 GHz was 530 and the quality factor Q (Q=μ1/μ2) at 1 GHz was 17.

Table 1 shows the measurement values including these results. As shown in Table 1, the respective examples in this embodiment can provide saturated magnetization equal to or higher than 1.4 T, resonance frequency equal to or higher than 1.5 GHz , and a Q value equal to or higher than 5.0. Among them, Examples 1 to 4 and 7 to 10 for which T1 is in the range from 0.5 to 3.0 nm and T1/T2 is in the range from 0.8 to 3.0 saturated magnetization of 1.4 T or more, resonance 2.0 GHz or more, and a Q value of 10.0 or more.

TABLE 1

| | | C content | | | Saturated | Resonance | | | | | |
|---|---|---|---|---|---|---|---|---|---|---|---|
| | Structure of | in Fe—C | T1 | | magnetization | frequency | μ1 (at | μ2 (at | Q (at 1 | Resistivity | Coercitivity |
| | magnetic thin film | (at %) | (nm) | T1/T2 | (T) | (GHz) | 1 GHz) | 1 GHz) | GHz) | (μΩcm) | Hce (Oe) |
| Example 1 | (1.0 nm CoZrNb/ | 10 | 1.0 | 1.0 | 1.43 | >>2.0 | 515 | 35 | 15 | 150 | 0.6 |
| | 1.0 nm Fe—C) × 250 | | | | | | | | | | |
| Example 2 | (0.9 nm CoZrNb/ | 10 | 1.3 | 1.4 | 1.41 | Up to 2.0 | 490 | 45 | 11 | 130 | 0.6 |
| | 1.3 nm Fe—C) × 170 | | | | | | | | | | |
| Example 3 | (1.0 nm CoZrNb/ | 10 | 2.0 | 2.0 | 1.48 | >>2.0 | 590 | 25 | 24 | 145 | 0.7 |
| | 2.0 nm Fe—C) × 170 | | | | | | | | | | |
| Example 4 | (1.0 nm CoZrNb/ | 10 | 2.8 | 2.8 | 1.50 | >>2.0 | 550 | 25 | 22 | 140 | 0.8 |
| | 2.8 nm Fe—C) × 20 | | | | | | | | | | |
| Example 5 | (0.8 nm CoZrNb/ | 10 | 2.8 | 3.5 | 1.58 | >>2.0 | 400 | 25 | 16 | 140 | 0.9 |
| | 2.8 nm Fe—C) × 140 | | | | | | | | | | |
| Example 6 | (2.0 nm CoZrNb/ | 10 | 1.0 | 0.5 | 1.39 | 1.7 | 755 | 130 | 6 | 125 | 0.6 |
| | 1.0 nm Fe—C) × 170 | | | | | | | | | | |
| Comparative | (6 nm CoZrNb/ | 10 | 7 | 1.1 | 1.30 | 1.6 | 1050 | 40 | 2.6 | 125 | 0.6 |
| Example 1 | 7 nm Fe—C) × 30 | | | | | | | | | | |
| Comparative | (20 nm CoZrNb/ | 10 | 30 | 1.5 | 1.69 | >2.0 | 505 | 84 | 6 | 45 | 0.6 |
| Example 2 | 30 nm Fe—C) × 10 | | | | | | | | | | |
| Comparative | (1.0 nm CoZrNb/ | — | 1.0 | 1.0 | 2.07 | — | 150 | — | — | 70 | 4.2 |
| Example 3 | 1.0 nm Fe—C) × 250 | | | | | | | | | | |
| Example 7 | (1.0 nm CoZrNb/ | 12 | 1.0 | 1.0 | 1.41 | >2.0 | 600 | 50 | 12 | 140 | 0.6 |
| | 1.0 nm Fe—C) × 250 | | | | | | | | | | |
| Example 8 | (1.0 nm CoZrNb/ | 15 | 1.0 | 1.0 | 1.40 | Up to 2.0 | 750 | 60 | 12 | 130 | 0.6 |
| | 1.0 nm Fe—C) × 250 | | | | | | | | | | |
| Example 9 | (1.0 nm CoZrNb/ | 10 | 1.0 | 1.0 | 1.44 | >>2.0 | 520 | 35 | 15 | 150 | 0.6 |
| | 1.0 nm Fe—C) × 250 | | | | | | | | | | |
| Example 10 | (1.0 nm CoFeZrB/ | 10 | 1.0 | 1.0 | 1.50 | >>2.0 | 530 | 30 | 17 | 140 | 0.6 |
| | 1.0 nm Fe—C) × 250 | | | | | | | | | | |

Although the present invention has been described by some embodiments and examples, the present invention is not limited to these embodiments and examples and various modifications are possible. For example, ferromagnetic metals and amorphous metals for forming the DM structure are not limited to the materials and compositions described in the above embodiments and examples. The magnetic thin film for high frequencies can be applied not only to a high-frequency flat type magnetic device such as thin film inductor, thin film transformer and a device such as MMIC but also to other devices.

What is claims:

1. A magnetic thin film for high frequencies comprising a DM (discontinuous multilayer) structure formed of ferromagnetic metal in amorphous state and amorphous metal different from the ferromagnetic metal.

2. The magnetic thin film according to claim 1, wherein the ferromagnetic metal is predominantly composed of iron (Fe) or iron-cobalt (FeCo) and contains one or more element(s) selected from the group of carbon (C), boron (B), and nitrogen (N), and the amorphous metal is a cobalt (Co)-base amorphous alloy.

3. The magnetic thin film according to claim 1, wherein the amorphous metal is cobalt-zirconium-niobium (CoZrNb).

4. The magnetic thin film according to claim 1, wherein the ferromagnetic metal has a film thickness equal to or less than 3.0 nm.

5. The magnetic thin film according to claim 1, wherein a film thickness of the ferromagnetic metal is in the range of 0.5 nm to 2.0 nm.

6. The magnetic thin film according to claim 1, wherein a ratio of a film thickness of the ferromagnetic metal to a film thickness of the amorphous is in the range of 0.8 to 3.0.

7. The magnetic thin film according to claim 1, wherein a ratio of a film thickness of the ferromagnetic metal to a film thickness of the amorphous metal is in the range of 1.0 to 2.5.

8. The magnetic thin film according to claim 1, wherein the ferromagnetic metal and the amorphous metal are alternately layered in a repeated manner.

9. The magnetic thin film according to claim 8, wherein the number of repetitions of layering the ferromagnetic metal and the amorphous metal are in the range of 5 to 3000 or less and the total thickness of layered films is in the range of 100 nm to 2000 nm.

10. The magnetic thin film according to claim 8, wherein the number of repetitions of layering the ferromagnetic metal and the amorphous metal are in the range of 10 to 700 and the total thickness of layered films is in the range of 300 nm to 1000 nm.

11. A method of manufacturing a magnetic thin film for high frequencies having a DM (discontinuous multilayer) structure formed of ferromagnetic metal and amorphous metal, comprising:
a ferromagnetic metal deposition step of depositing the ferromagnetic metal so that amorphous state is maintained; and
an amorphous metal deposition step of depositing amorphous metal different from the ferromagnetic metal,
wherein the ferromagnetic metal deposition step and the amorphous metal deposition step are alternately performed a plurality of times to form the DM structure.

12. The method for manufacturing a magnetic thin film according to claim 11, wherein the ferromagnetic metal is predominantly composed of Fe or FeCo and contains one or more element(s) selected from the group of C, B, and N, and the amorphous metal is a Co-base amorphous alloy.

13. A magnetic device having one or more magnetic thin films for high frequencies, wherein the magnetic thin film has a DM (discontinuous multilayer) structure formed of ferromagnetic metal in amorphous state and amorphous metal different from the ferromagnetic metal.

14. The magnetic device according to claim 13, further comprising a coil,
wherein the magnetic thin films are provided to be opposed to each other so as to sandwich the coil.

15. The magnetic device according to claim 13, wherein the magnetic device is used for an inductor or a transformer.

16. The magnetic device according to claim 13, wherein the magnetic device is used for a monolithic microwave integrated circuit.
